(19) United States
(12) Patent Application Publication
(10) Pub. No.: US 2025/0355261 A1
(43) Pub. Date: Nov. 20, 2025

(54) ELECTRONIC DEVICE WITH MODULAR COMPONENTS

(71) Applicant: Apple Inc., Cupertino, CA (US)

(72) Inventors: Ibuki Kamei, Santa Clara, CA (US); Alison B. Shutzberg, San Francisco, CA (US); Ennzhi Chew, Sunnyvale, CA (US); Josiah C. Frye, Kenmore, WA (US)

(21) Appl. No.: 18/957,305

(22) Filed: Nov. 22, 2024

Related U.S. Application Data
(60) Provisional application No. 63/649,559, filed on May 20, 2024.

(51) Int. Cl. G02B 27/01; G02C 11/00; G06F 1/16; H04R 1/02

(52) U.S. Cl. CPC G02B 27/0176; G02C 11/10; G06F 1/163; H04R 1/028; G02C 2200/08

(57) ABSTRACT

A wearable display device can include, a display frame, a securement arm, a battery, a speaker, and a printed circuit board (PCB). The securement arm of the device can have a proximal end and removably couple to the display frame and a distal end opposite the proximal end, and the securement arm can define a singular seamless shell. The PCB can couple to the battery and electrically couple to the speaker via an electrical conductor. The length of the conductor being greater than a distance between the PCB and the speaker within the shell. The shell defines an opening at the proximal end of the arm through which the battery and the PCB can be removed together without interrupting the electrical connection between the PCB and the speaker via the conductor.

### CROSS-REFERENCE TO RELATED APPLICATION

This application claims the benefit of U.S. Provisional Patent Application No. 63/649,559, filed 20 May 2024, and entitled “ELECTRONIC DEVICE WITH MODULAR COMPONENTS,” the entire disclosure of which is hereby incorporated by reference.

### FIELD

The examples of the present disclosure relate generally to electronic devices. More particularly, the examples of the present disclosure relate to head-mountable electronic devices.

### BACKGROUND

Various components of head-mountable electronic devices, such as display screens, viewing frames, securement arms, speakers, batteries, waveguides, and other components, operate together to provide an immersive and comfortable experience. These devices can demand power for operation from power sources such as batteries. Due to a limited lifespan, batteries sometimes need to be accessed and/or replaced. Batteries for head-mountable electronic devices can be positioned in the securing arms that connect the head-mountable electronic device to a user's head. However, the accessibility of the batteries in these securing arms is often in tension with the design of the securing arms, limiting the replace-ability of the batteries.

### SUMMARY

The present disclosure provides a wearable display device. A wearable display device can include, a display frame, a securement arm, a battery, a speaker, and a printed circuit board (PCB). The securement arm of the device can have a proximal end removably connected to the display frame and a distal end opposite the proximal end, and the securement arm can define a singular seamless shell. The PCB can couple to the battery and electrically connect to the speaker via an electrical conductor, the length of the conductor being greater than a distance between the PCB and the speaker within the shell. The shell defines an opening at the proximal end of the arm through which the battery and the PCB can be removed together without interrupting the electrical connection between the PCB and the speaker via the conductor.

In one example, the wearable device can further include a transparent window coupled to the display frame. The wearable device can include a projector that can direct light displayed at the transparent window. The electrical conductor of the wearable device can be made from a flexible printed circuit. The wearable device can further include a curved arm tip secured to the distal end of the securement arm. The wearable display device can further include a battery as a first battery and a second battery disposed within the securement arm. The curved arm tip can be removably secured to the distal end of the securement arm.

In another example, a wearable electronic device can include a display frame coupled to a display window. The wearable electronic device can further include a securement arm, and the securement arm can include a proximal arm including a shell pivotally coupled to the display frame at a proximal end of the shell, and the shell can have a distal end opposite the proximal end. The securement are can further include a distal arm that can couple to the distal end, and the distal end defining an internal volume having a first curvature. The wearable electronic device can further include, a first battery disposed within the shell and removable from the securement arm through an opening defined at the proximal end of the shell. The wearable electronic device can further include a second battery disposed within the distal arm, and the second battery can have a second curvature that approximates the first curvature to fit within the internal volume and can be removable from the securement arm.

In another example, the wearable electronic device can further include a charging port cap that can be removably secured to the distal end of the distal arm. The second battery can be attached to the charging port cap and can be removed from the distal arm. The distal arm can further include a first shell and a second shell, wherein the second shell is a battery housing. The distal arm can be removable from the proximal arm. The second shell of the distal arm can be removable from the distal arm.

In at least one example, a securement arm for a wearable electronic device can include a proximal housing having a first proximal end and a first distal end opposite the first proximal end. The securement arm can further include a distal housing that can define a first curve to accommodate to an ear of a user, and the distal housing can have a second proximal end removably coupled to the first distal end of the proximal housing. A second distal end opposite of the second proximal end. The securement arm can further include a battery disposed within the distal housing and the battery can define a second curve that approximates the first curve. The charging port cap can be disposed at the second distal end.

In one example, a battery can be in the distal housing and can have a second housing. The charging port cap can be removably coupled to the second distal end of the distal housing. The securement arm can further include a first battery and a second battery that can be disposed within the proximal housing. The securement arm can further include a blind connection mechanism that can include a biasing member that can be adjustably engaged with an inner surface at or near the first distal end. The connection mechanism can further include a groove defined by the second proximal end configured to engage the biasing member when the second proximal end is inserted into the first distal end. A canted surface can be defined by at least one of the biasing members or the second proximal end and configured to expand the biasing member when the second proximal end is inserted into the first distal end. The securement arm can further include another example of a connection mechanism. The connection mechanism can include a canted surface that is the first canted surface, and a groove that can define a second canted surface having a different angle than the first canted surface. The securement arm can further include a first seal disposed between the first distal end and the second proximal end and defining an external surface of the securement arm. The securement arm can further include a second seal that can be disposed within the proximal housing and between the proximal housing and the distal housing.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a rear isometric view of an electronic device with modular components;

FIG. 2 illustrates an exploded view of a securement arm;

FIG. 3A illustrates a cross-sectional view of a battery and a speaker housed in the securement arm;

FIG. 3B illustrates a cross-sectional view of the battery removed from the housing of the securement arm with slack of the electrical conductor pulled out;

FIG. 4A illustrates a cross-sectional view of the battery and the speaker housed in the securement arm;

FIG. 4B illustrates a cross-sectional view of the battery and the speaker removed as one piece from the housing of the securement arm;

FIG. 5A illustrates the securement arm with a cap assembly for the battery replaceability;

FIG. 5B illustrates the cap assembly removed from the securement arm exposing the battery;

FIG. 6A illustrates a side-view of the arm tip connected to the securement arm;

FIG. 6B illustrates a side-view of one example of removing the battery from the housing of the arm tip, according to the present disclosure;

FIG. 7A illustrates a side-view of the arm tip connected to the securement arm;

FIG. 7B illustrates a side-view of one example of removing the battery from the housing of the arm tip, according to the present disclosure;

FIG. 8A illustrates one example of a connection mechanism connecting the arm tip to the securement arm, according to the present disclosure;

FIG. 8B illustrates one example of removing the arm tip from the securement arm, according to the present disclosure;

FIG. 9A illustrates one example of a connection mechanism connecting the arm tip to the securement arm, according to the present disclosure;

FIG. 9B illustrates one example of removing the arm tip from the securement arm, according to the present disclosure; and

FIG. 10 illustrates one example of securing the arm tip to the securement arm.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The present disclosure generally relates to electronic devices. More particularly, the present disclosure relates to head-mountable electronic devices. In at least one example, a head-mountable electronic device can include a frame and a securement arm extending from the frame. The securement arm can include a battery, a printed circuit board (PCB) and/or a speaker at a proximal end of the securement arm during use. The securement arm can further include a battery and/or power port positioned at a distal end or tip of the securement arm. Examples of head-mountable devices can include optical devices (e.g., glasses, transparent windows, etc.) or virtual/augmented reality devices that can include an optical component. In these cases, the head-mountable device can be worn on the head of a user such that optically transparent widows, for example, lenses and transparent optical displays, can be positioned in front of a user's eyes. Other electrical components for the powering and operation of the device can also be disposed in the device, for example data ports and waveguides. Batteries can be disposed distally and proximally on the securement arm, and can be electrically coupled to the various other electronic components of the device.

Current wearables devices can include batteries or power sources at locations designed to not interfere with the user's experience and to not create discomfort during use. The securement arms of a head mountable device described herein are designed for comfort and securement during long-term use. Any electrical components, including a power source and other components mentioned herein, which can be placed in or on the securement arm itself, can be designed and placed strategically to avoid interfering with the weight distribution, securement forces, comfort, and/or field of view of the device and the user.

As noted above, in at least one example, the battery can be disposed in the proximal end of the securement arm, wherein the speaker and the battery can be electrically coupled and removed as a single piece when replacing the battery. This can enable the securement arm to maintain a seamless housing exterior. In this way, the user can experience a comfortable experience when the user dons the head-mountable device for long durations. The seamless housing exterior can be advantageous as it can simplify the manufacturing process, can reduce the stress concentrations that can occur at seams while the user may don the electronic device, and can increase the aesthetic appeal of the electronic device.

In at least one example, the battery can be coupled with a PCB and can be disposed in the proximal end of the securement arm, wherein only the battery and PCB are removed from the housing of the securement arm. In this way, an electric conductor can electrically couple the battery and the speaker enabling slack or a service loop to form in the housing of the securement arm when both the battery and speaker are housed in the securement arm. The length of the conductor can be greater than a distance between the PCB and the speaker within the shell. This can enable the battery to be removed from the housing of the securement arm with the electrical conductor still coupling the speaker and the PCB. In this way, the battery can be replaced without removing the speaker from the securement arm housing. The battery can be replaced without removing any portions of the securement arm housing. In this way, the securement arm can remain as a seamless housing piece as the battery and PCB are removed from an opening defined by the securement arm. This can be advantageous as enabling a seamless housing piece to remain seamless during battery replacement can increase the aesthetic appeal of the securement arm on the electronic device, and can also simplify the manufacturing process of the securement arm.

In some examples, the battery can be disposed in the proximal end of the securement arm, wherein a cap assembly can be defined by a portion of the securement arm. In this way, the cap can be removed to expose the battery. The battery can be uncoupled from the housing of the securement arm and replaced. Then the cap can be secured to the body after replacing the battery. This can enable the replaceability of the battery without removing the securement arm from a hinge on a display frame.

In at least one example, the battery can be housed in an arm tip in the distal end of the securement arm. In some examples, the arm tip of the securement arm can be disposed behind a user's ear when the user dons the head-mountable device. In this way, the arm tip can curve to fit around a user's ear for securement. The battery can be curved to fit into the housing of the arm tip. In at least one example, a charging port cap can be removably coupled to the arm tip. In this way, the battery is free to be removed from the curved portion of the arm tip. This can enable replaceability of the battery without sacrificing seamless housing exterior of the arm tip and comfortability for the user.

In at least one example, the battery can be housed in an arm tip, wherein the battery can be removed via a button assembly. A removable battery sled can include the charging port cap, the battery and button assembly, and can be removably coupled to the arm tip. This can enable the user to replace the battery housed in the arm tip with the push of a button and without the assistance of a third party professional.

In at least one example, the arm tip can be removably coupled to the securement arm, wherein the user can replace the entire arm tip when replacing the battery. In this way, the arm tip connector and battery are permanently housed within the arm tip. This enables the user to replace the entire arm tip when changing the battery housed in the arm tip, and can enable the user to change the battery without the assistance of a third party professional.

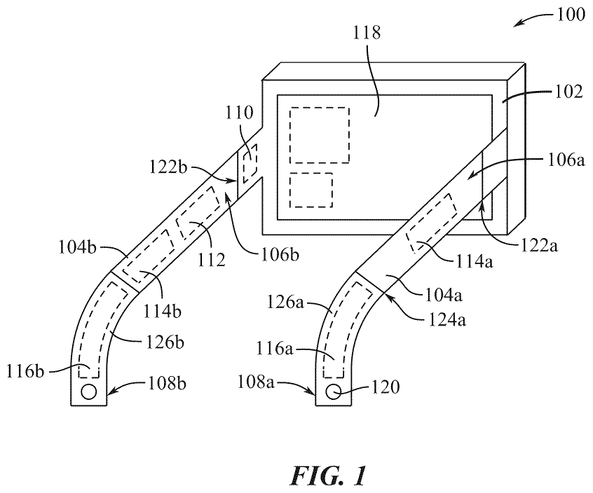

These and other embodiments are discussed below with reference to FIGS. 1-10. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a rear isometric view of an electronic device 100 with modular components. The electronic device with modular components 100 can be a head-mountable electronic device or can be any device or system configured to be worn on the a head of a user, such as a head-mountable electronic device, an optical device, smart glasses, alternate/virtual reality goggles, and the like. As shown in FIG. 1, the device 100 can include at least one display frame 102, which can house a variety of components and systems. In at least one example, the display frame 102 can be configured to secure one or more display windows 118 configured to present visual information to the user. In one or more examples of the present disclosure, the display windows 118 can include optically transparent display windows, display screens, transparent material, optical lenses, or transparent display screens, or combinations thereof, in front of the eyes of the user. The device 100 can include at least one securement arm 104. According to the example shown in FIG. 1, at least one of the securement arms 104a and 104b can be attached to the display frame 102. Securement arms 104a and 104b can include proximal ends 106a and 106b, which can be attached to the display frame 102. Securement arms 104a and 104b can further include distal ends 108a and 108b further extending from the proximal ends 106a and 106b, respectively. In other examples, the securement arms 104a and 104b can be a single securement arm, a flexible band, or the like.

In at least one example, the securement arms 104a and 104b can include a first joint 122a and 122b. The first joints 122a and 122b can be place between the proximal ends 106a and 106b of the securement arms 104a and 104b and the display frame 102. In this example, the securement arms 104a and 104b can be removably coupled or connected to the display frame 102. According to the example of FIG. 1, the securement arms 104a and 104b can also include second joints 124a and 124b, which can be located between the proximal ends 106a and 106b and the distal ends 108a and 108b of the securement arms 104a and 104b. The combination of the first and second joints 122s, 122b, 124a, and 124b can be advantageous to the user in that the device 100 can better conform to a wide variety of user head and face sizes and shapes. Better conformity to different sizes and shapes can result in greater comfort felt by a wide range of user wearing the device 100, as well as enabling sufficient retention when the user moved while donning the device 100.

FIG. 1 also illustrates the use of other components that can be housed inside the securement arms 104a and 104b. In at least one example, the securement arms 104a and 104b can house a variety of different components including, but not limited to, a battery 112, a projector 110, and at least one speaker 114. According to the example of FIG. 1, the securement arm 104b can house the battery 112, the projector 110, and the speaker 114b. In this example, the securement arm 104a can house the speaker 114a. In examples where the securement arms 104a and 104b can include at least one projector 110, the projectors 110 can be configured to direct light displayed at the window 118 attached to the display frame 102. The use of the battery 112 can be advantageous to the user of the device 100 to extend usage time. The battery 112 can allow the user to operate the device 100 without having to frequently interrupt operation to charge the device 100, thereby increasing productivity and efficiency of use for the user.

According to the example of FIG. 1, the device 100 can include arm tips 126a and 126b that can removably couple or connect to the distal end of the securement arms 104a and 104b. The arm tips 126a and 126b can be defined as a portion or section of the securement arm 104a and 104b configured to be disposed behind the ear of the user when the device 100 is donned. According to the example of FIG. 1, the arm tips 126a and 126b curve downward to comfortably fit behind the user's ears. In this example, the user can adjust the arm tips 126a and 126b curvature to conform the fit of the arm tips 126a and 126b around the user's ears. In at least one example, a battery 116a and 116b can be housed inside of the arm tips 126a and 126b. In this way, the battery 116a and 116b can curve to conform to the curvature of the arm tips 126a and 126b. The arm tips 126a and 126b can further include a charging port cap 120. In one example, the charging port cap 120 can define a through hole extending through a thickness of the arm tip 126. The use of the battery 116a and 116b can be advantageous to the user of the device 100 to extend the usage time. Batteries 116a and 116b can allow the user to operate the device 100 without having to frequently interrupt operations to charge device 100, thereby increasing productivity and efficiency of use for the user.

Any of the features, components, and/or parts, of the electronic device including the arrangements and configurations thereof shown in FIG. 1 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1.

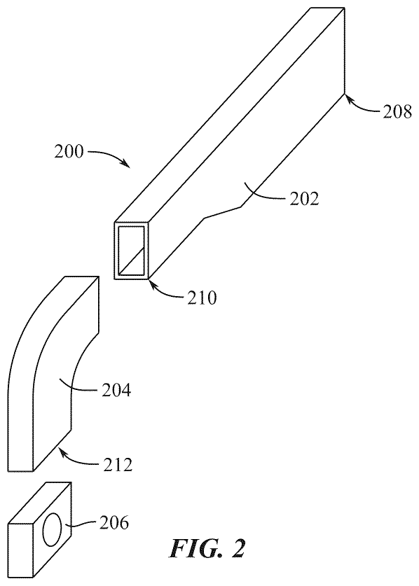

FIG. 2 illustrates an exploded view of a securement arm 200. In at least one example, the securement arm 200 can be removably coupled, or connected, to the display frame 102. The securement arm 200 can be separated into different sections. As shown in FIG. 2, the securement arm 200 can include a proximal arm 202 with a proximal end 208 that can removably couple to the display frame 102. In this example, the proximal arm 202 can be a singular, seamless shell with a distal end 210 opposite the proximal end 208. The proximal arm 202 can be seamless such that the proximal arm 202 is formed as a unitary piece without multiple parts being assembled to form the single proximal arm 202. The shell of the proximal arm 202 can define a curvature to accommodate an ear of a user. A singular, seamless shell as the proximal arm 202 can be advantageous to the user of the device 100 in that the seamless shell can increase the comfortability during long durations of the user donning the device 100. In another example, the seamless shell of the proximal arm 202 can be advantageous as the seamless shell can increase the aesthetic appeal of the device 100. In one example, the seamless shell can simplify the manufacturing process of the proximal arm 202. Furthermore, the seamless shell can reduce the stress concentrations that can occur at seams while the user dons the electronic device.

As shown in FIG. 2, the shell of the proximal arm 202 can have different size openings defined by the distal end 210 and the proximal end 208. In one example, the distal end 210 can have a smaller opening defined by the proximal arm 202. In this way, the shape of the shell defines a curvature of the proximal arm 202 to create a seamless fit between the proximal arm 202 and the distal arm 204 at the distal end 210 of the proximal arm 202. In one example, the proximal end 208 can define a larger opening in the proximal arm 202 where the proximal arm can removably couple to the display frame 102. The larger defined opening on the proximal end 208 of the proximal arm 202 can be advantageous for replaceability of electrical components.

In at least one example, the securement arm 200 can further include a distal arm 204 that can removably couple to a distal end 210 of the proximal arm 202. The distal arm 204 can define an internal volume having a curvature. The curvature of the distal arm 204 can cause the distal arm 204 to be positioned behind the user's ear during use. The curvature of the distal arm 204 can be advantageous to increase the comfortability as the user dons the device 100. In at least one example, the distal arm 204 can further include a charging port cap 206 disposed at a second distal end 212. As shown in FIG. 2, the charging port cap 206 can be removably coupled to the second distal end 212 of the distal arm 204. The removability of the charging port cap 206 from the distal arm 204 can be advantageous for the process of replaceability of the battery that can be housed in the internal volume defined by the distal arm 204.

Any of the features, components, and/or parts, of the electronic device including the arrangements and configurations thereof shown in FIG. 2 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 2.

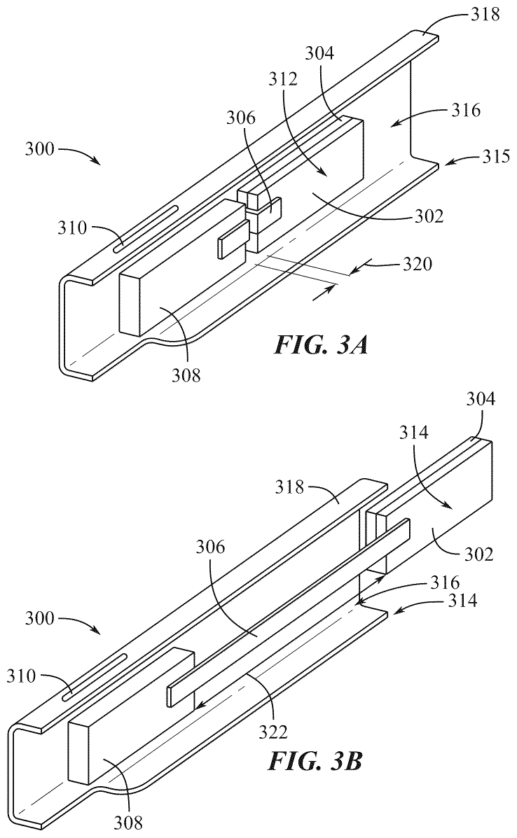

FIGS. 3A and 3B illustrate a cross-section view of a securement arm 300. In one example, the securement arm 300 can define an internal volume. In this way, the securement arm 300 can house any number of components. These components can include, but are not limited to, a battery 304, a PCB 302, a speaker 308, and an electrical conductor 306. As shown in FIGS. 3A and 3B, the securement arm 300 can house the speaker 308, the PCB 302, the battery 304, and the electrical conductor 306. In one example, the speaker 308 can be disposed within the shell of the securement arm 300 distal to the battery 304. In this example, disposing the speaker 308 distal to the battery 304 can be advantageous as the speaker 308 can stay housed in a shell 318 of the securement arm 300 as the battery 304 can be removed and replaced. In this way, the speaker 308 can remain sealed to an acoustic ports 308, 310 during the replacement of the battery 304. In this example, a PCB 302 can be coupled or connected to the battery 304. In this way the PCB 302 can be electrically coupled to the speaker 308 via an electrical conductor 306. In one example, the electrical conductor 306 can be a flexible printed circuit. As seen in FIG. 3A, the length of the electrical conductor 306 can be greater than a distance between the PCB 302 and the speaker 308 within the shell of the securement arm 300.

In one example, the shell of the securement arm 300 can define an opening 316 at the proximal end 315 of the securement arm 300. The opening 316 can allow the battery 304 and the PCB 302 to be removed together without interrupting the electrical connection between the PCB 302 and the speaker 308 via the electrical conductor 306.

As seen in FIG. 3A, the speaker 308, the PCB 302, and the battery 304 can be in a first position 312 housed in the shell 318 of the securement arm 300. The first position 312 can be the normal and/or intended operating positions of the PCB 302, the battery 304, and the speaker 308 inside the securement arm 300 while a user dons the device 100 on the user's head. In one example, the PCB 302 and the battery 304 can define a distance 320 from the speaker 308 when in the first position 312. The proximal end 315 of the securement arm 300 can be removably attached to a display frame 102. The portion of the securement arm 300 extending away from the display frame 102 can expose an opening 316 defined by the proximal end 315 of the securement arm 300. In one example, the securement arm 300 can define a shell 318. In this way, the battery 304 and the PCB 302 can be housed within the shell 318 of the securement arm 300. The battery 304 and the PCB 302 can be removed from the internal volume of the shell 318 and through the opening 316 defined at the proximal end 315 of the arm 300.

As seen in FIG. 3B, the PCB 302 and the battery 304 can be removed together from the shell 318 of the securement arm 300 to a second position 314. The opening 316 defined at the proximal end 315 of the securement arm 300 can allow the PCB 302 and the battery 304 to be removed from the shell 318 while the PCB 302 can still be electrically coupled to the speaker 308 via the electrical conductor 306. As seen in FIG. 3B, when the PCB 302 and the battery 304 translate to the second position 314, the electrical conductor 306 can define or exhibit a length 322 greater than the distance 320 defined between the PCB 302, the battery 304 and the speaker 308 when inside the securement arm 300. In one example, the electrical conductor 306 can extend through the opening 316 during the removal of the battery 304 and the PCB 302. The electrical conductor 306 being longer than the distance between the PCB 302 and the speaker 308 can be advantageous when replacing the battery 304 as the PCB can maintain its electrical connection to the speaker 308 during the process of changing the battery 304. In one example, when the battery 304 and the PCB 302 are in the second position 314, the battery 304 can be removably coupled to the PCB 302 to enable the replace-ability of the battery 304. In this way, the PCB 302 can maintain its electrical coupling to the speaker 308 while the battery 304 can be replaced. This can be advantageous to reduce the wear and tear of electrical connections and components as disconnecting of electrical components is minimized during the process of replacing the battery 304. This removal of the battery 304 through the opening 316 and the resulting reduction in disconnecting components during battery 304 replacement can make the replacement simple and easy with the singular, seamless shell 318.

Any of the features, components, and/or parts, of the electronic device including the arrangements and configurations thereof shown in FIGS. 3A and 3B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 3A and 3B.

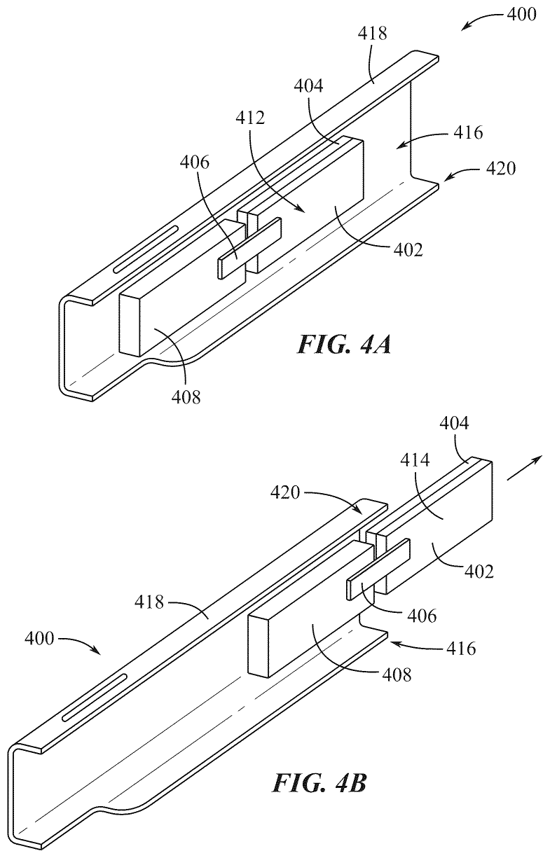

FIG. 4A illustrates a cross-section view of a securement arm 400. In one example, the securement arm 400 can removably attach to a display frame 102 at a proximal end 420 of a securement arm 400. In one example, the securement arm 400 can define a singular, seamless shell 418, and can define an internal volume. In at least one example, the securement arm 400 can house any number of components. These components can include, but are not limited to, a battery 404, a PCB 402, a speaker 408, and an electrical conductor 406. In this way, the securement arm 400 can define an opening 416 on the proximal end, wherein the battery 404, the PCB, 402, the speaker 408, and the electrical conductor 406 can be removed together. As shown in FIG. 4A, the speaker 408 is disposed distal to the battery 404, wherein the battery 404 can be removably coupled to the PCB 402. In one example, the electrical conductor 406 length can be long enough to electrically couple the speaker 408 to the PCB 402. As shown in FIG. 4A, the speaker 408, the battery 404, the PCB 402, and the electrical conductor 406 can be in a first position 412. The first position 412 can be the position the electrical components can be in during normal and/or intended operating positions of the device 100.

FIG. 4B illustrates a cross-sectional view of a securement arm 400. In one example, the battery 404, the PCB 402, the speaker 408, and the electrical conductor 406 can be removed together through the opening 416 defined by the proximal side 420 of the securement arm 400. As shown in FIG. 4B, the battery 404, the PCB 402, the speaker 408, and the electrical conductor 406 can translate together from a first position 412 to a second position 414. In this way, the PCB 402 can maintain an electrical connection to the speaker 408 as the battery 404 is accessed or replaced. This can be advantageous as the battery 404 can be replaced while the shell of the securement arm 400 maintains a seamless shell 418 for cosmetic appeal and comfortability of the user.

Any of the features, components, and/or parts, of the electronic device including the arrangements and configurations thereof shown in FIGS. 4A and 4B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 4A and 4B.

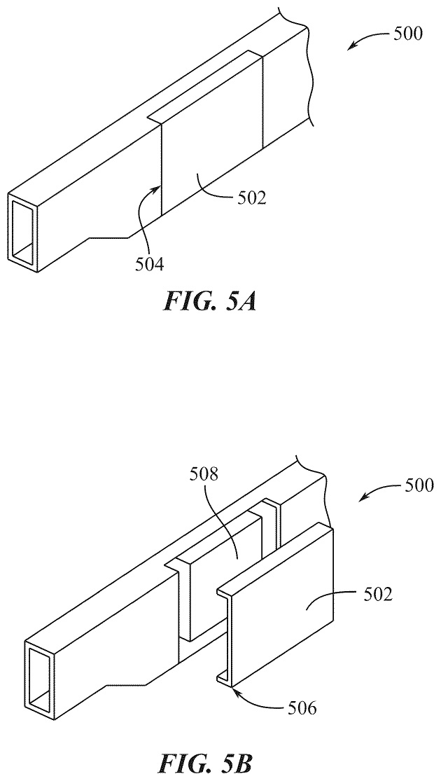

FIG. 5A. Illustrates a securement arm 500 with a cap assembly 502. In one example, the securement arm 500 can define a cap assembly 502. The cap assembly 502 can be attached to the securement arm 500 by heat activated adhesive, liquid adhesive, or the like. As shown in FIG. 5A, the cap assembly 502 can be defined on the interior surface of the securement arm 500. This can be advantageous to enable the securement arm 500 to maintain cosmetic appeal on the exterior surface while the user dons the device 100. In one example, the cap assembly 502 can be housed on the exterior surface of the securement arm 500. As shown in FIG. 5A, the cap assembly 502 can be in a first position 504. The first position 504 can be the cap assembly 502 position during normal operations of the device 100.

FIG. 5B illustrates a cap assembly 502 removed from the securement arm 500. In one example, the securement arm 500 can define a cap assembly 502 that can be removed from the shell of the securement arm 500. In at least one example, the cap assembly 502 can be attached to a securement arm 500 by a re-workable liquid adhesive, a heat activated adhesive, or the like. In this way, the cap assembly 502 can be removed to a second position 506 to expose a battery 508 housed within the securement arm 500. In one example, the battery 508 can be replaced in the housing of the securement arm 500, then the cap assembly 502 can be re-attached to the housing of the securement arm 500. This can be advantageous as the user can bring device 100 to a third party professional for a battery 508 replacement.

In at least one example, the cap assembly 502 can include a button, tab, lever, or other actuator. In this way, the securement arm 500 can include a sealed button-release assembly. According to this example, the cap assembly 502 can be removably coupled to the housing of the securement arm 500. For example, the user can push, slide, or otherwise actuate the button, tab, lever, or other actuator on the cap assembly 502, releasing the cap from the sealed button assembly and the housing of the securement arm 500. In this way, the cap assembly 502 can expose the battery 508 when removed from the housing of the securement arm 500. This can be advantageous, as the user can remove the cap assembly 502 and replace the battery 508 without assistance from a third party professional.

Any of the features, components, and/or parts, of the electronic device including the arrangements and configurations thereof shown in FIGS. 5A and 5B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 5A and 5B.

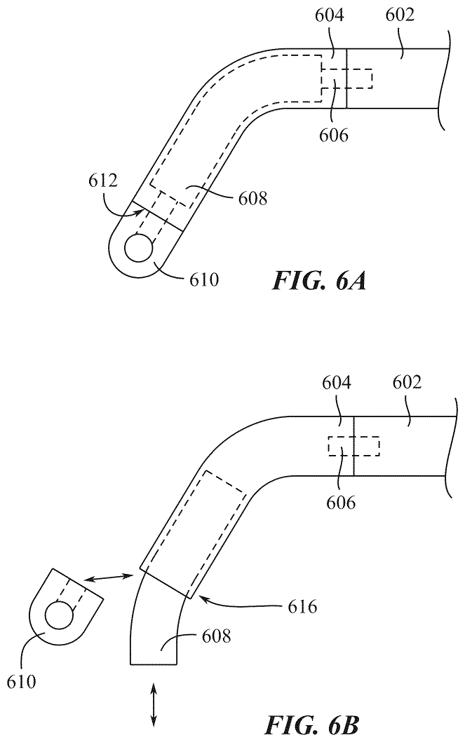

FIG. 6A illustrates a side-view of a distal housing 604 connected to a securement arm 602. In one example, the distal end of the proximal housing or securement arm 602 can removably couple to a distal housing 604. As shown in FIG. 6A, the distal housing 604 can define a first curve. The distal housing 604 can removably coupled to the distal end of the securement arm 602. The curvature can be advantageous to secure the distal housing 604 behind the user's ear when the user dons the device 100.

In one example, the distal housing 604 can define an internal volume defining a first curvature. The internal volume of the distal housing 604 can house many electrical components. For example, a battery 608 can be housed within the distal housing 604. In one example, the battery 608 can be housed in the internal volume of the distal housing 604 having a curvature. In this way the battery 608 can define a second curvature that approximates the first curvature to fit within the internal volume and being removable from the distal housing 604. This can be advantageous to create curvature in the distal housing 604 to better secure the distal housing 604 behind the ears of the user when the user dons the device 100.

In one example, the battery 608 is housed within the distal housing 604, and can be electrically coupled to the electrical components housed within the securement arm 602 via an electrical conductor 606. In one example, the battery can define a curve to match the curve of the distal housing 607 in order to fit within the distal housing 604. As shown in FIG. 6A, the distal housing 604 can include a second proximal end removably coupled to the first distal end of the securement arm 602, the securement arm 602 including a second distal end opposite the second proximal end. In at least one example, a charging port cap 610 can be removably coupled to the second distal end 612 of the distal housing 604. The charging port cap 610 can be electrically coupled to the battery 608 in the distal housing 604. In at least one example, the charging port cap 610 defines a through-hole extending through the thickness of the distal housing 604.

FIG. 6B illustrates a side-view of one example of removing the battery from the distal housing 604, according to the present disclosure. In at least one example, the charging port cap 610 can be removably coupled to the distal end of the distal housing 604. In one example, the distal housing 604 can define an opening 616 on the second distal end 612. As shown in FIG. 6B, the charging port cap 610 can be removed to expose the battery 608 housed within the distal housing 604. The removal of the charging port cap 610 from the distal housing 604 can enable the battery 608 to translate from the opening 616 defined by the distal housing 604.

In at least one example, the battery 608 can be disconnected from the electrical conductor 606 and can be removed from the distal housing 604. As shown in FIG. 6B, the replacement battery 608 can be reinstalled through the opening 616 defined in the distal housing 604. In this way, the charging port cap 610 can be reattached to the distal end of the distal housing 604, which can enable the battery 608 to be secured into the distal housing 604 and be electrically coupled with the electrical conductor 606. In one example, the charging port cap 610 can be attached to the distal housing 604 by a re-workable liquid adhesive seal, heat-activated adhesive, or the like.

Any of the features, components, and/or parts, of the electronic device including the arrangements and configurations thereof shown in FIGS. 6A and 6B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 6A and 6B.

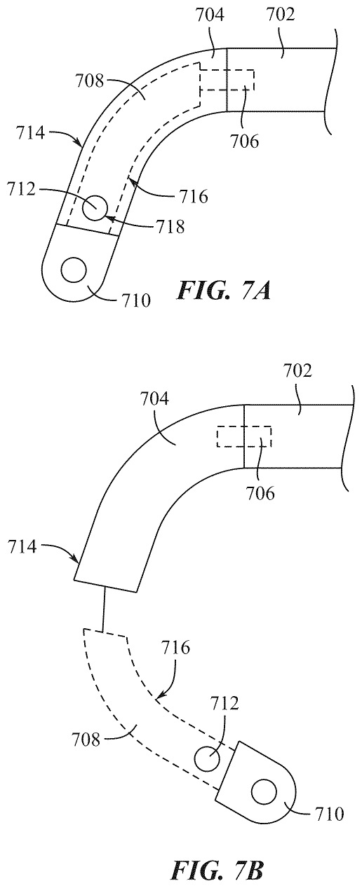

FIG. 7A illustrates a side-view of the distal housing 704 connected to the securement arm 702. As shown in FIG. 7A, the distal housing 704 can be a curved distal housing 704 that can removably couple to the distal end of the securement arm 702. In one example, the distal housing 704 can include a first shell 714 and a second shell 716, wherein the battery 708 can be disposed in the second shell 716. In one example, the battery 708 housed within the distal housing 704 can be electrically coupled to the electrical components housed within the securement arm 702 via an electrical conductor 706. In at least one example, the battery can be fixedly coupled or fixedly attached to a charging port cap 710.

In at least one example, the distal housing 704 can further include at least one button assembly 712. The first shell of the distal housing 704 can define an opening 718 that can secure a button assembly 712. In one example, the button assembly 712 is fixedly coupled or fixedly attached to the second shell 716. As shown in FIG. 7A, the button assembly 712 can protrude through the opening 718 defined within the first shell 714 of the distal housing 704 which can secure the second shell 716 and battery 708 during normal operation of the device 100.

FIG. 7B illustrates a side-view of one example of removing the battery 708 from the housing of the arm tip, according to the present disclosure. In at least one example, the button assembly 712 can be depressed to enable to the second shell 716 to translate out of the distal housing 704. As shown in FIG. 7B, the battery 708 and the second shell 716 can be permanently coupled to the charging port cap 710, wherein the battery 708, the second shell 716, and the charging port cap 710 are removably coupled to the distal housing 704. This can be advantageous, as the user can remove the battery 708 from the distal housing 704, to replace the existing battery 708 with a replacement battery 708.

As shown in FIG. 7A, in one example, the battery 708 can include a housing. In this way, the housing can be in the distal housing 704. In at least one example, the distal housing 704 can be removably coupled to the securement arm 702, wherein the whole distal housing 704 can be replaced during battery 708 replacement. In such an example, the distal housing 704 of the securement arm 702 can be a housing of the battery 708 itself. In this example, the battery 708 can be fixedly disposed within the distal housing 704. For example, the battery 708 can include the housing inside the distal housing 704. In this way, the charging port cap 710 can further be permanently coupled to the distal housing 704 and the battery 708. This can be advantageous, as the user can replace only the distal housing 704 during battery 708 replacement. This can also simplify the manufacturing process by facilitating manufacture of the distal housing 704 as a single piece.

Any of the features, components, and/or parts, of the electronic device including the arrangements and configurations thereof shown in FIGS. 7A and 7B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 7A and 7B.

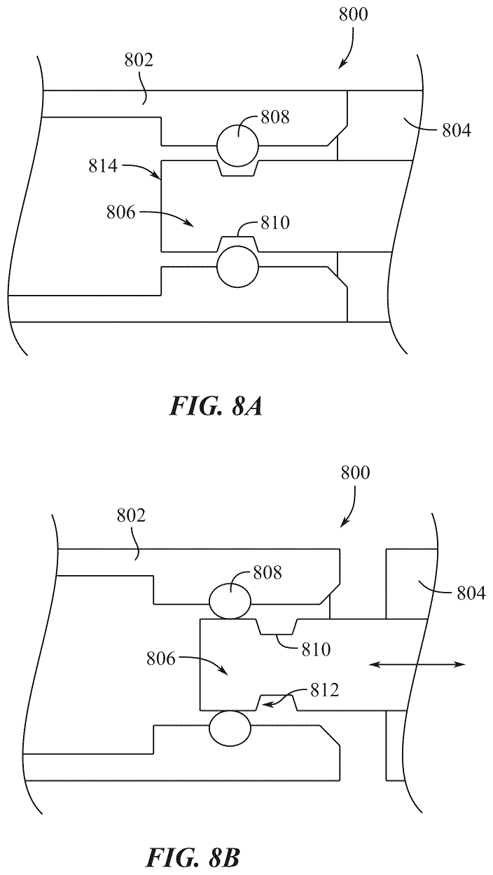

FIG. 8A illustrates one example of a connection mechanism 800 securing the arm tip 804 to the securement arm 802, according to the present disclosure. In one example, the securement arm 802 can include a blind connection mechanism 800 that can removably couple the securement arm 802 to the arm tip 804. The connection mechanism 800 can include at least one biasing member 808. The biasing member 808 can adjustably engage with an inner surface near the first distal end. As shown in FIG. 8A the biasing member 808 can include a canted coil spring, or the like.

In one example, the arm tip 804 can include a second proximal end 806 that can engage with the connection mechanism 800. In one example, the second proximal end 806 can include a first edge 814 that can interact with the biasing member 808. In this way, the first edge 814 can expand the biasing member 808 when inserting the second proximal end 806 into the connection mechanism 800. In another example, a groove 810 can be defined by the second proximal end 806 that can engage with the biasing member 808 of the connection mechanism 800. In this way, the biasing member 808 can engage with a groove 810 to secure the arm tip 804 to the securement arm 802.

FIG. 8B illustrates one example of a connection mechanism 800 removing the arm tip 804 from the securement arm 802, according to the present disclosure. In one example, a canted surface 812 can be defined by at least one of the biasing members 808 or by the second proximal end 806. In one example, the canted surface 812 can expand the biasing member 808 when the second proximal end 806 is removed from the connection mechanism 800, wherein the arm tip 804 can be removably coupled with the securement arm 802. In this example, the second proximal end 806 can experience a low insertion force and can experience a relatively high extraction force. In one example, the biasing member 808 can be adjusted to increase or decrease the insertion and extraction forces required by varying the cant angle, the coil size or properties, and the like. In another example, the angle of the first edge 814 and the canted surface 812 can be adjusted to increase or decrease the insertion and extraction forces required.

Any of the features, components, and/or parts, of the electronic device including the arrangements and configurations thereof shown in FIGS. 8A and 8B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 8A and 8B.

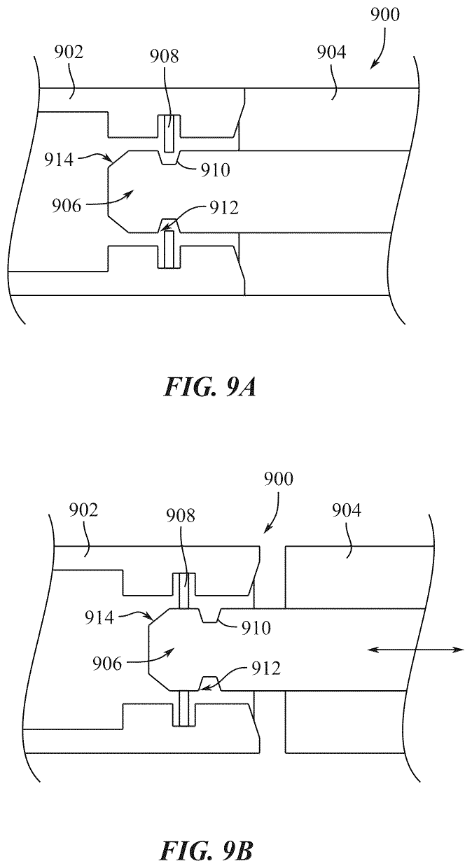

FIG. 9A illustrates one example of a connection mechanism connecting the arm tip to the securement arm, according to the present disclosure. In one example, the securement arm 902 can include a blind connection mechanism 900 that can removably couple the securement arm 902 to the arm tip 904. The connection mechanism 900 can include at least one biasing member 908. The biasing member 908 can adjustably engage with an inner surface near the first distal end. As shown in FIG. 9A the biasing member 908 can include a C-Clip Spring, or the like.

In one example, the arm tip 904 can include a second proximal end 906 that can engage with the connection mechanism 900. In this way, the second proximal end 906 can include a first canted surface 914 that can engage with the biasing member 908. For example, the first canted surface 914 can expand the biasing member 908 when inserting the second proximal end 906 into the connection mechanism 900. In another example, a groove 910 can be defined by the second proximal end 806 that can engage with the biasing member 908 of the connection mechanism 900. In this way, the biasing member 908 can engage with a groove 910 to secure the arm tip 904 to the securement arm 902. In one example, the angle of the first canted surface 914 can be adjusted to increase or decrease the insertions force needed to secure the arm tip 904 to the securement arm 902. In at least one example, the biasing member 908 can be externally assembled on the second proximal end 906 or can be internally assembled within the housing of the securement arm 902. In another example, the biasing member 908 can be adjusted as to increase or decrease the insertion force and extraction force.

FIG. 9B illustrates one example of a connection mechanism and removing the arm tip from the securement arm 902, according to the present disclosure. In one example, the groove 910 can define a second canted surface 912 defined by at least one of the biasing members or the second proximal end. The second canted surface 912 can have a different angle than that of the first canted surface 914. This can be advantageous, as the first canted surface 914 can require an insertion force needed to secure the arm tip 904 to the securement arm 902 less than an extraction force needed to remove the arm tip 904 from the securement arm 902. For example, the second canted surface 912 can expand the biasing member 908 when extracting the second proximal end 906 from the connection mechanism 900. In one example, the angle of the second canted surface 912 can be adjusted to change the extraction force used to remove the arm tip 904 from the securement arm 902.

Any of the features, components, and/or parts, of the electronic device including the arrangements and configurations thereof shown in FIGS. 9A and 9B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 9A and 9B.

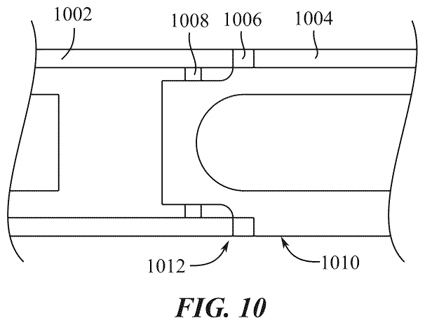

FIG. 10 illustrates one example of securing the arm tip 1004 to the securement arm 1002. In one example, the securement arm 1002 can include a first seal 1006. The first seal 1006 can be disposed between the first distal end 1012 and the second proximal end 1010. For example, the first seal 1006 can define an external surface of the securement arm 1002. This can be advantageous, as a first seal 1006 can be a cosmetic seal under compression or tension to define a continuous external surface between the securement arm 1002 and the arm tip 1004 as a position of the arm tip 1004 is changed relative to the securement arm 1002 during user adjustment and fitting. In another example, the securement arm 1002 can include a second seal 1008. The second seal 1008 can be disposed within the housing of the securement arm 1002 and between the housing of the securement arm 1002 and the housing of the arm tip 1004. In this position, the second seal 1008 can protect internal electrical components housed in the securement arm 1002 as an environmental seal.

Any of the features, components, and/or parts, of the electronic device including the arrangements and configurations thereof shown in FIG. 10 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 10.

To the extent applicable to the present technology, gathering and use of data available from various sources can be used to improve the delivery to users of invitational content or any other content that can be of interest to them. The present disclosure contemplates that in some instances, this gathered data can include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data can be used to provide insights into a user's general wellness, or can be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user can be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A wearable display device, comprising:
a display frame;
a securement arm including a proximal end removably coupled to the display frame and a distal end opposite the proximal end, the securement arm defining a singular seamless shell;
a battery disposed within the shell;
a speaker disposed within the shell distal to the battery; and
a printed circuit board (PCB) coupled to the battery and electrically coupled to the speaker via an electric conductor, a length of the conductor being greater than a distance between the PCB and the speaker;
wherein the shell defines an opening at the proximal end of the arm sized for removal of battery and the PCB without interrupting the electrical coupling between the PCB and the speaker via the conductor.

2. The wearable display device of claim 1, further comprising:
a transparent window coupled to the display frame; and
a projector configured to direct light displayed at the transparent window.

3. The wearable display device of claim 1, wherein the conductor comprises a flexible printed circuit.

4. The wearable display device of claim 1, further comprising a curved arm tip secured to the distal end of the securement arm.

5. The wearable display device of claim 4, wherein:
the battery is a first battery; and
the wearable display device further comprises a second battery disposed within the curved arm tip.

6. The wearable display device of claim 4, wherein the curved arm tip is removably secured to the distal end of the securement arm.

7. A wearable electronic device, comprising:
a display frame coupled to a display window;
a securement arm, the securement arm comprising:
a proximal arm comprising a shell pivotally coupled to the display frame at a proximal end of the shell, the shell having a distal end opposite the proximal end; and
a distal arm coupled to the distal end, the distal end defining an internal volume having a first curvature;
a first battery disposed within the shell and removable from the securement arm through an opening defined at the proximal end of the shell; and
a second battery disposed within the distal arm, the second battery having a second curvature that approximates the first curvature to fit within the internal volume and being removable from the securement arm.

8. The wearable electronic device of claim 7, further comprising a charging port cap removably secured to the distal end of the distal arm.

9. The wearable electronic device of claim 7, wherein the second battery is configured to be fixedly attach to the charging port cap and removable from the distal arm.

10. The wearable electronic device of claim 7, the distal arm further comprising a first shell and a second shell, wherein the second shell includes a housing of the second battery.

11. The wearable electronic device of claim 7, wherein the distal arm is removable from the proximal arm.

12. The wearable electronic device of claim 10, wherein the second shell is removable from the distal arm.

13. A securement arm for a wearable electronic device, the securement arm comprising:
a proximal housing having a first proximal end and a first distal end opposite the first proximal end;
a distal housing defining a first curve configured to accommodate an ear of a user, the distal housing having:
a second proximal end removably coupled to the first distal end of the proximal housing; and
a second distal end opposite the second proximal end;
a battery disposed within the distal housing, the battery defining a second curve that approximates the first curve; and
a charging port disposed at the second distal end.

14. The securement arm of claim 13, wherein the battery comprises a housing including the distal housing.

15. The securement arm of claim 13, wherein the charging port is removably coupled to the second distal end of the distal housing.

16. The securement arm of claim 13, wherein:
the battery is a first battery; and
the securement arm further comprises a second battery disposed within the proximal housing.

17. The securement arm of claim 13, wherein the charging port cap defines a through-hole extending through a thickness of the distal housing.

18. The securement arm of claim 13, further comprising a blind connection mechanism including:
a biasing member adjustably engaged with an inner surface at or near the first distal end;
a groove defined by the second proximal end configured to engage the biasing member when the second proximal end is inserted into the first distal end; and
a canted surface defined by the biasing member or the second proximal end and configured to expand the biasing member when the second proximal end is inserted into the first distal end.

19. The securement arm of claim 18, wherein:
the canted surface is a first canted surface; and
the groove defines a second canted surface having a different angle than the first canted surface.

20. The securement arm of claim 13, further comprising:
a first seal disposed between the first distal end and the second proximal end and defining an external surface of the securement arm; and
a second seal disposed within the proximal housing and between the proximal housing and the distal housing.
